(19) United States
(12) Patent Application Publication
(10) Pub. No.: US 2010/0293149 A1
(43) Pub. Date: Nov. 18, 2010

(54) System and Method for Providing Simultaneous, Multiple Case Scenario Analysis

(75) Inventor: Rakesh Kabra, North Brunswick, NJ (US)

Correspondence Address: WENDY W. KOBA, PO BOX 556, SPRINGTOWN, PA, 18081, US

(73) Assignee: Easy Soft LLC

(21) Appl. No.: 12/753,232

(22) Filed: Apr. 2, 2010

Related U.S. Application Data
(60) Provisional application No. 61/178,778, filed on May 15, 2009.

(51) Int. Cl. G06F 17/30

(52) U.S. Cl. 707/668; 707/E17.007

(57) ABSTRACT

A system and method for creating and maintaining multiple scenarios associated with a legal proceeding has been developed to automatically create and maintain multiple scenarios in a manner where key parameters (such as party status) can be modified and the remaining elements of the file adjusted automatically. An initial case file scenario is created with data provided by a client. Various other scenarios are then automatically created from the initial case file scenario without the need to re-enter the client data, thus eliminating the possibility of data entry error.

### CROSS-REFERENCE TO RELATED APPLICATION

This application claims the priority of U.S. Provisional Application No. 61/178,778, filed May 15, 2009 and herein incorporated by reference.

### TECHNICAL FIELD

The present invention relates to a system and method for providing simultaneous, multiple legal case scenarios and, more particularly, to automatically creating and maintaining multiple scenarios in a manner where key parameters (such as party status) can be modified and the remaining elements of the scenario automatically adjusted.

### BACKGROUND OF THE INVENTION

In many professional services, the need arises to study different fact patterns—scenarios—where some factors are unknown, others are changeable for various reasons, and some remain constant. It is problematic in that changes in some factors cause changes in others, rendering the ability to develop multiple, different scenarios a difficult task. Oftentimes, an individual will need to develop a separate and distinct set of different scenarios and then, as factors change, remember to change the factors in each scenario and re-determine the impact of that change on other factors.

One specific professional service where this problem occurs is in the practice of law, where case documents will depend on a number of changing (or interchangeable) factors, all of which affect the calculations, results and presentation of a case. For example, a party's status as either a custodial or non-custodial parent will not be known during a divorce proceeding until the final decree is presented. Thus, an attorney representing one of the parents must develop a scenario for both the “non-custodial” and “custodial” fact pattern.

Presently, one method of coping with multiple scenarios in legal proceedings is to prepare multiple copies of a “main” file. In each copy, data is entered and calculations are made assuming a particular fact (such as the party's status, e.g., “plaintiff”, “defendant”, “custodial”, “non-custodial”, and the like). Once a final decree is entered, the copy of the “main” file that fits the fact pattern of the decree is retained as the case file, and the others are destroyed.

However, as mentioned above, creating and maintaining multiple files is a time-consuming task, which is also prone to introducing errors into one or more of the files (e.g., certain changes may not be carried over from one file to the next, the multiple case files may not all be updated at the same time, etc.). Over time, any mistakes will accumulate and may lead to a situation where the individual providing the service is no longer confident in the integrity of any file.

### SUMMARY OF THE INVENTION

These and other file management problems of the prior art are addressed by the present invention, which relates to a system and method for creating and maintaining multiple scenarios associated with a legal proceeding and, more particularly, to automatically creating and maintaining multiple scenarios in a manner where key parameters (such as party status) can be modified and the remaining elements of the file adjusted automatically.

In accordance with the present invention, an initial case file scenario is created with data provided by a client. Various other scenarios are then automatically created from the initial case file scenario without the need to re-enter the client data, thus eliminating the possibility of data entry error.

It is an advantage of the system and method of the present invention that various factors which have only a few, predetermined values (such as, for example, a party's status in a legal matter) are saved in a manner that allows for the factor to be changed (such as, for example, changing a party's status from “custodial” to “non-custodial” with respect to parental responsibilities) and for the all of the remaining pertinent information stored in that specific scenario to be automatically re-calculated and updated. Moreover, if a specific scenario is no longer applicable, that scenario may be eliminated without upsetting the parameters in the remaining scenarios.

Another advantage of the method and system of the present invention is that the multiple scenarios can be viewed simultaneously, such as by selecting a key value, allowing for the user to study and compare all of the scenarios at the same time. The views may even be condensed into a “summary” format for easier review. This comparison also allows for the user to review any values that are changing, adjust one or more scenarios and create new scenarios, if need be.

Other advantages and aspects of the present invention will become apparent during the course of the following discussion and by reference to the accompanying drawings.

### BRIEF DESCRIPTION OF THE DRAWINGS

Referring now to the drawings,

FIG. 1 illustrates an exemplary system architecture that may be used to implement the multiple scenario case analysis system of the present invention;

FIG. 2 is a screen shot of an exemplary implementation of the present invention; and

FIG. 3 shows another screen shot, in this case illustrating the creation of multiple scenarios from an initial case file scenario.

### DETAILED DESCRIPTION

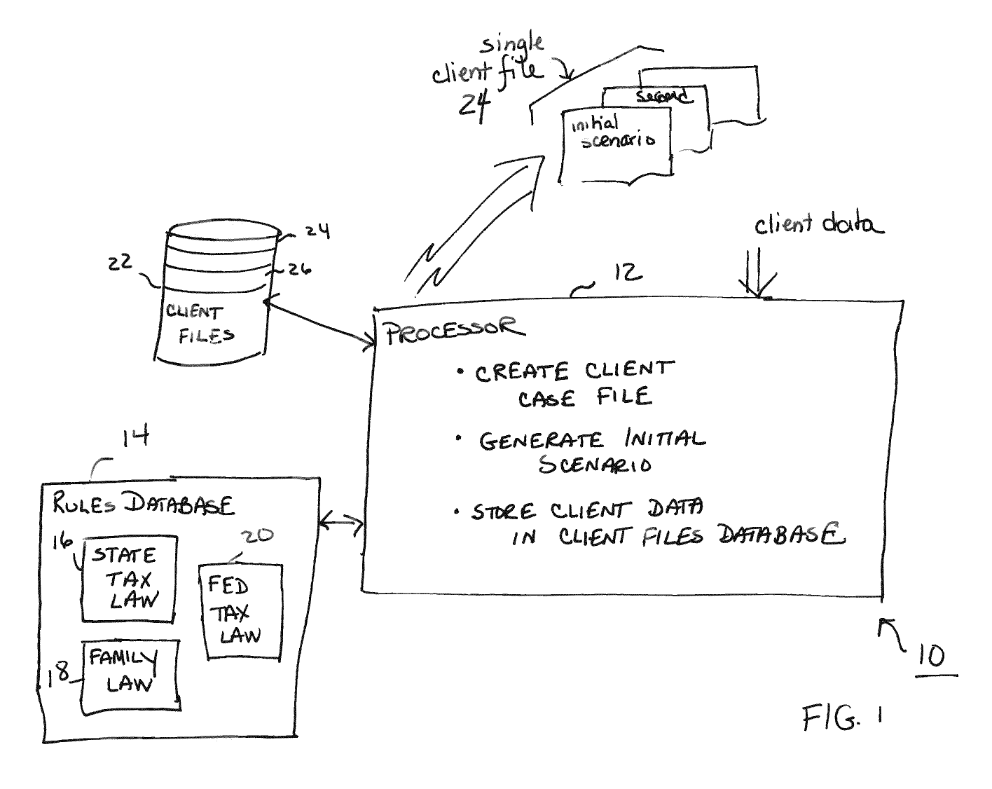

A schematic representation of an exemplary multiple scenario case analysis system 10 of the present invention is illustrated in FIG. 1. System 10 is implemented on a computer system that includes a storage medium and at least one processor. In particular, system 10 is shown as including a processor 12 that creates a case file including an initial scenario, based upon client data input. A statute-driven rules database 14 is included in system 10 and includes a variety of modules that are used to calculate different values that are input to a scenario. In the exemplary embodiment of FIG. 1, database 14 is shown as including a state tax law module 16, a state family law module 18 and a federal tax law module 20. Obviously, as the various laws are updated the associated modulates are updated as well.

In accordance with the present invention, processor 12 utilizes the client input data to create a general ‘case file’ and an initial scenario. The exemplary embodiment as shown in FIG. 1 also includes a client files database 22 for storing various client files 24, 26, etc. Client file 24, as will be discussed in detail, is used to create multiple scenarios that can be reviewed, evaluated and used in determining the progress and resolution of a particular case. Presuming, for the sake of illustration, a client child custody file 24 is being created, the client input data may include the client's name, income, “status” (custodial or non-custodial), names and ages of children. By accessing database 14, processor 10 is able to create an initial scenario (denoted as “IS” in FIG. 1) showing support amounts and the like. This initial scenario may define a certain number of “overnight” visits per year to the non-custodial parent. In order to assess the changes in the case by modifying the number of overnight visits, a second scenario (“SS”) is created and maintained within the same client child custody file 24.

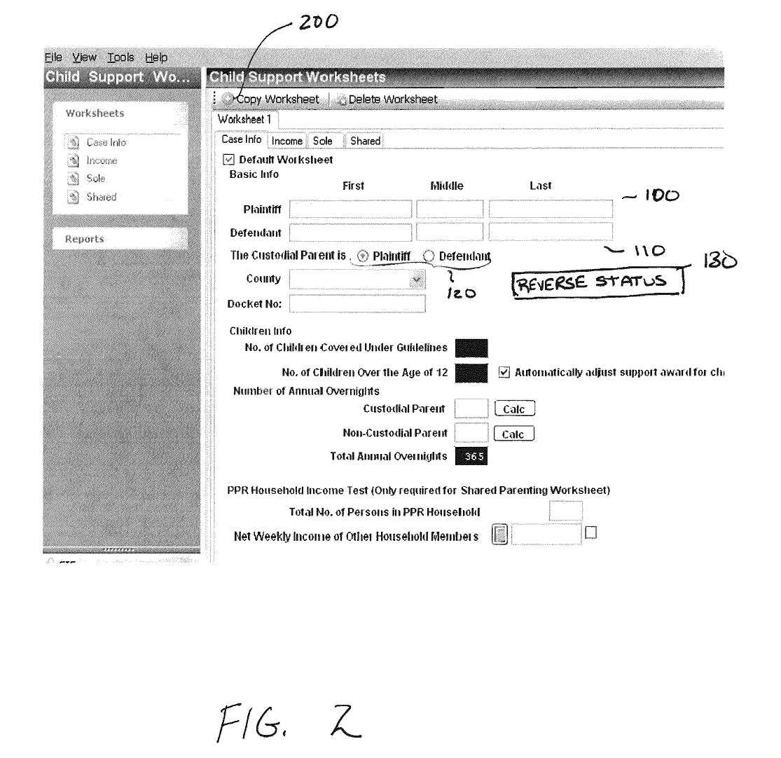

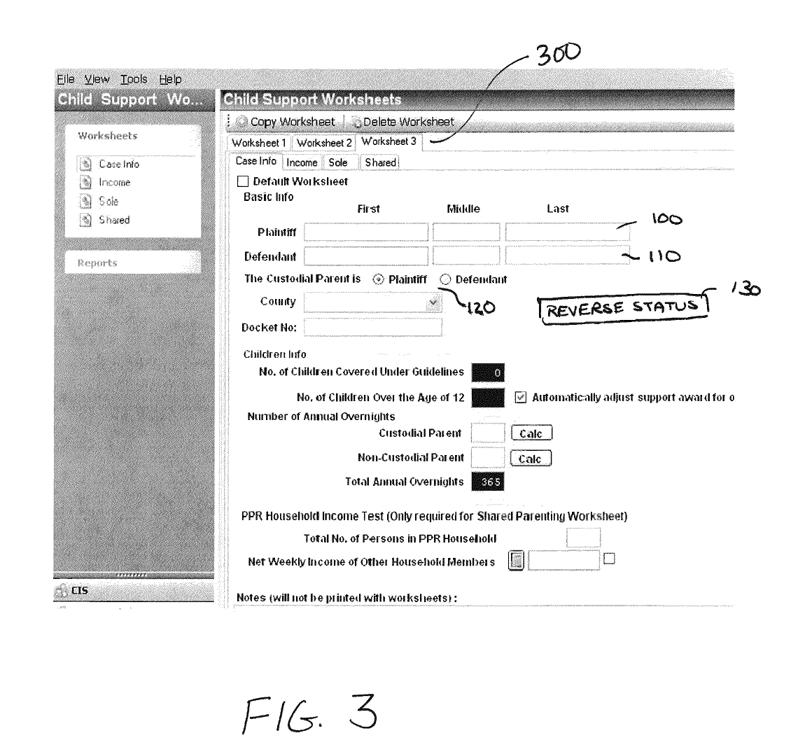

Advantageously and in accordance with the present invention, processor 12 functions to create the second scenario using the data stored in client child custody file 24 and automatically “copying” the first scenario (in the manner described below in association with FIGS. 2 and 3) and modifying the value of the “overnight” visits. The ability to electronically collect the initial scenario parameters and re-populate a blank child custody worksheet avoids problems with data entry errors, as possible in the prior art. In particular, the initial scenario is “copied” to form a second scenario where one or more values are changed. The two scenarios can be then easily be compared in real time to assess the impact of the changes made in the second scenario. This process can be repeated, with multiple scenarios being created and compared against each other. The comparison may yield a conclusion that a particular scenario is no longer pertinent, and it can therefore be deleted without impacting the remaining scenarios.

The screen shot of FIG. 2 illustrates an exemplary implementation of the method and system of the present invention, highlighting the ability to copy information from one scenario to another, as well as the ability to separate each scenario into multiple sections. The screen shot of FIG. 2 is, for the purposes of discussion, a “child support worksheet” and includes information for the “plaintiff” in record 100 and the “defendant” in record 110. A button selector 120 is used to define the custodial parent. It is one aspect of the present invention that the exemplary scenario may be modified by changing the identity of the custodial party, shown as ‘reverse status’ bar 130 in FIG. 2.

Other client input data used to populate the initial worksheet of FIG. 2 includes the number of children, the number of annual overnights and, for “shared parenting” situations, the total number of persons in the “parent of primary residence” (PPR) household and net weekly income of other household members.

In accordance with the present invention, another child support worksheet (that is, another ‘scenario’) is easily and quickly created by clicking on “copy worksheet” button 200 at the top of the page. The data stored in client file 24 of database 22 (see FIG. 1) is then used to create a second worksheet, still retained within the same client file 24. Different ones of the values within one or more fields may then be changed, creating a different scenario based on the same original client input information. Additional scenarios may be created by merely clicking on “copy worksheet” button 200 as many times as needed.

FIG. 3 is another screen shot, showing the creation of multiple scenarios (in this example, three worksheets are shown as present along status bar 300) and highlighting the ability of change a party's status, where the method of the invention will then reverse all values within the scenario that are impacted by this change. This example is using a divorce software application where husband and wife are divorcing and each is seeking custody of their children. As part of the divorce application, there is a child support worksheet where, based on each party's information and status, child support amounts are calculated. Assuming that the case is in progress, the party's custodial status is not known and various other factors continue to be negotiated. The multiple scenarios are used to consider various aspects of the case such as, for example, child support, number of children over age 12, visitation parameters, and the like.

Indeed, another aspect of the present invention is the creation of a separate summary sheet for each scenario, which dynamically captures all of the critical parameters from each scenario and presents them in a single document. The creation of a single document summarizing each of the scenarios allows for the users to immediately see the impacts of various scenarios and, importantly, how changing one or two factor values changes all inter-related aspects of the scenarios. This additional summary ability can be used as part of a final decision-making process, or as an impetus to prepare yet another scenario, etc.

Although the method and system of the present invention have been described relative to a specific embodiment thereof, the principles of the invention are not so limited. Obviously, many modifications and variations may become apparent in light of the above teachings. Many additional changes in the details, materials and arrangement of parts, herein described and illustrated, can be made by those skilled in the art. Accordingly, it will be understood that the following claims are not limited to the embodiment disclosed herein and can including practices other than those specifically described herein.

What is claimed is:

1. A multiple scenario case analysis system comprising
a processor configured to: (1) receive client data, (2) create a client case file, (3) generate an initial scenario including the client data and a plurality of variable parameters, the values of the plurality of variable parameters calculated results based on said client data and (4) generate multiple scenarios by copying the initial scenario and modifying selected ones of the variable parameters;
a rules database, coupled to the processor, to provide specific information used to calculate results for the variable parameters; and
a client database for storing each created client case file.

2. A multiple scenario case analysis system as defined in claim 1 wherein the processor is further configured to create a summary of each created scenario.

3. A multiple scenario case analysis system as defined in claim 1 wherein the processor is further configured to reverse a status of the client and automatically recalculate the values of the plurality of parameters.

4. A multiple scenario case analysis system as defined in claim 3 wherein the status is reversed between the two values of “plaintiff” and “defendant”.

5. A multiple scenario case analysis system as defined in claim 3 wherein the status is reversed between the two values of “custodial” and “non-custodial”.

6. A method of creating multiple scenarios for case analysis, the method comprising the steps of:
receiving client input data;
creating an initial scenario based on the client data and a plurality of variable parameters;
copying the initial scenario at least one time to create a second scenario containing the same client data;
modifying at least one variable parameter in the second scenario; and
performing the copying and modifying steps a desired number of times to create a multiple number of scenarios.

7. The method as defined in claim 6 wherein the method further includes the step of:
reversing a client status in a selected scenario; and
recalculating the plurality of variable parameters based upon the reversed client status.

8. The method as defined in claim 6 wherein the method further includes the step of:
creating a summary of each scenario for evaluating the multiple scenarios.
